(19) United States
(12) Patent Application Publication
(10) Pub. No.: US 2012/0230553 A1
(43) Pub. Date: Sep. 13, 2012

(54) APPARATUS AND METHOD FOR DETECTING EYE STATE

(75) Inventor: Deepak Chandra Bijalwan, Bangalore (IN)

(73) Assignee: LG INNOTEK CO., LTD., Seoul (KR)

(21) Appl. No.: 13/393,675

(22) PCT Filed: Sep. 1, 2010
(86) PCT No.: PCT/KR10/05934

§ 371 Date: May 18, 2012

(30) Foreign Application Priority Data
Sep. 1, 2009 (KR) 10-2009-0082055

(51) Int. Cl. G06K 9/46

(52) U.S. Cl. 382/117

(57) ABSTRACT

The present invention is directed to an eye state detecting apparatus and method, that is, including the step of preliminarily discriminating an eye opening and an eye closure by setting an automatic threshold from an eye region and thus dividing an image, and obtaining boundary points of divided zones and using an ellipse most properly equal to the boundary points and consecutively the step of in a case preliminarily discriminated as the eye closure, if an eye closure time is greater than a preset threshold time, the eye state is discriminated into an eye closure, and if not greater, discriminated into an eye blinking.

### TECHNICAL FIELD

The present invention is directed to an eye state detecting apparatus and method.

### BACKGROUND ART

An eye state detection is required in various fields such as a driver monitoring system preventing a drowsy driving, a computer game using an eye motion and a camera for picture photographing. A previous eye state detection could be divided into two kinds of categories: active infrared (IR) based approaches and visible spectrum/feature-based approaches. The visible spectrum/feature-based approaches are classified into a template based method, an appearance based method and a feature based method. NIR based methods are pragmatic and important to seek for visual spectrum methods. The template based method has been devised based on an eye shape, and a template matching is used to detect an eye image. Such a method should match an overall face among an eye template and pixels. Also, because an eye size versus an input face image is ignorant, a matching procedure to an eye template of another size should be repeated several times. Therefore, it can detect eyes accurately but consuming much time in doing this. An appearance based method detects eyes based on luminous intensity conditions. The method presents eyes of other subjects under usually different face tendencies and unlike illumination conditions and accompanies botheration collecting a bulk of operational data. The feature based method searches characteristics of eyes to identify several distinguished features around the eyes. Such methods are efficient, but has a disadvantage of insufficient accuracies on images with no striking contrast, for example confusing eyes and eyebrows.

An image based eye detecting approach positions eyes by developing eye differences in appearance and shape from a remainder of a face. Eye's special features such as black pupils, white scleras, round-shaped irises, the corner of eye(s), and eye shapes are used to distinguish human eyes from other objects. Such a method may be deficient of efficiency and accuracy, thereby incompetent to be realized.

### DISCLOSURE

### Technical Problem

The present invention provides an apparatus and a method for discriminating an eye state in real-time by higher accuracy and efficiency.

### Technical Solution

An eye state detecting method according to one embodiment of the present invention is provided, the method of detecting an eye state into an eye opening, an eye closure and an eye blinking from a continuous image containing a face, comprising: (a) inputting a basic still image from the continuous image, (b) detecting a facial region from the initial still image, (c) detecting an eye region from the facial region, (d) preliminarily discriminating an eye opening and an eye closure by dividing images through the setting of an automatic threshold from the eye region and obtaining boundary points of the divided zones and using an ellipse most properly equal to the boundary points, and (e) discriminating as an eye closure if an eye closure time calculated by repeating the step (a) through the step (d) as much as a preset times is greater than a preset threshold time and discriminating as an eye blinking if it is not greater, in a case preliminarily discriminated in the eye closure in the step (d).

An eye state detecting apparatus according to one embodiment of the present invention is provided, the apparatus of detecting an eye state into an eye opening, an eye closure and an eye blinking from a continuous image containing a face, comprising: a camera unit photographing the continuous image, and a signal processing unit discriminating an eye state into an eye opening, an eye closure and an eye blinking by performing an eye state detection based on an eye state detection method according to one embodiment of the present invention from the continuous image.

An eye state detecting method according to another embodiment of the present invention is provided, the method of detecting an eye state into an eye opening, an eye closure and an eye blinking from a continuous image containing a face, comprising: (a) inputting a basic, still image from the continuous image, (b) detecting a facial region and an eye region from the basic still image, (c) Log-Gabor filtering the detected eye region, (d) setting an automatic threshold into the eye region, (e) dividing binary images of the eye region and obtaining boundary points of divided zones, (f) equaling a most proper ellipse to the boundary points, (g) preliminarily discriminating an eye opening and an eye closure using the ellipse, and (h) discriminating as an eye closure if an eye closure time calculated by repeating the step (a) through the step (g) as much as a preset times is greater than a preset threshold time and discriminating as an eye blinking if it is not greater, in a case preliminarily discriminated in the eye closure in the step (g).

### Advantageous Effects

An eye state detecting method according to the present embodiment is advantageous in that it can discriminate an eye status in real-time with higher accuracy and efficiency. The eye state detecting method can be applied to an eye-shifting based information display system employing eyes as a pointing instrument, an eye-movement using computer game and an eye-blinking detectable camera, such as an eye state detection for a real-time eye-tracking, a driver monitoring system, and a mouse pointer navigating through a screen and selecting other items.

### DESCRIPTION OF DRAWINGS

FIG. 1 is an image showing a variety of eye states;

FIG. 2 is a flow diagram showing an eye state detecting method according to the embodiment;

FIG. 3 is a diagram indicating facial region detecting results according to the present embodiment;

FIG. 4 is a diagram showing one example of an algorithm detecting an eye region according to the present embodiment;

FIG. 5 is a diagram indicating eye region detecting results according to the present embodiment;

FIG. 6 is a flow diagram indicating an eye opening/closure discriminating step according to the present embodiment;

FIG. 7 is a diagram showing a cropped eye region according to the present embodiment;

FIG. 8 is a diagram showing 80 60 resized eye region according to the present invention;

FIG. 9 is a diagram indicating a Log Gabor kernel for a convolution used in the present embodiment;

FIG. 10 is a diagram indicating a filtered eye region according to the present embodiment;

FIG. 11 is a flow diagram indicating an automatic threshold setting step according to the present embodiment;

FIG. 12 is a diagram indicating one example of an algorithm conceived to calculate a 2D histogram entropy according to the present embodiment;

FIG. 13 is a diagram showing results before or after an automatic threshold setting according to the present embodiment;

FIG. 14 is a diagram showing a performance result of dividing binary images and obtaining boundary points of each divided zone according to the present embodiment;

FIG. 15 is a diagram showing a performance result of equaling an ellipse to each zone's boundary points according to the present invention;

FIG. 16 is an algorithm indicating one example of discriminating an eye opening/closure state according to the present embodiment; and

FIG. 17 is a block diagram showing an eye state detecting apparatus according to the present embodiment.

### BEST MODE

Since the present invention can have various changes thereto and several types of embodiments, specific embodiments intends to be exemplified in the drawings and minutely described in the detailed description. However, it should not be appreciated in a limiting sense of limiting the present invention to a specific example but to include all the changes, equivalents and replacements which fall in the spirit and technical scope of the present invention.

Stated that any component “is connected” or “is conjunctive” to another component, it will be appreciated to be directly connected or conjunctive to the very another component or otherwise that there exists any component in the midst of them.

In the following, a preferred embodiment according to the present invention will be described in detail referring to the attached drawings, but without regard to a drawing sign, an identical or corresponding component is assigned the same reference numeral and a redundant description regarding this will be omitted.

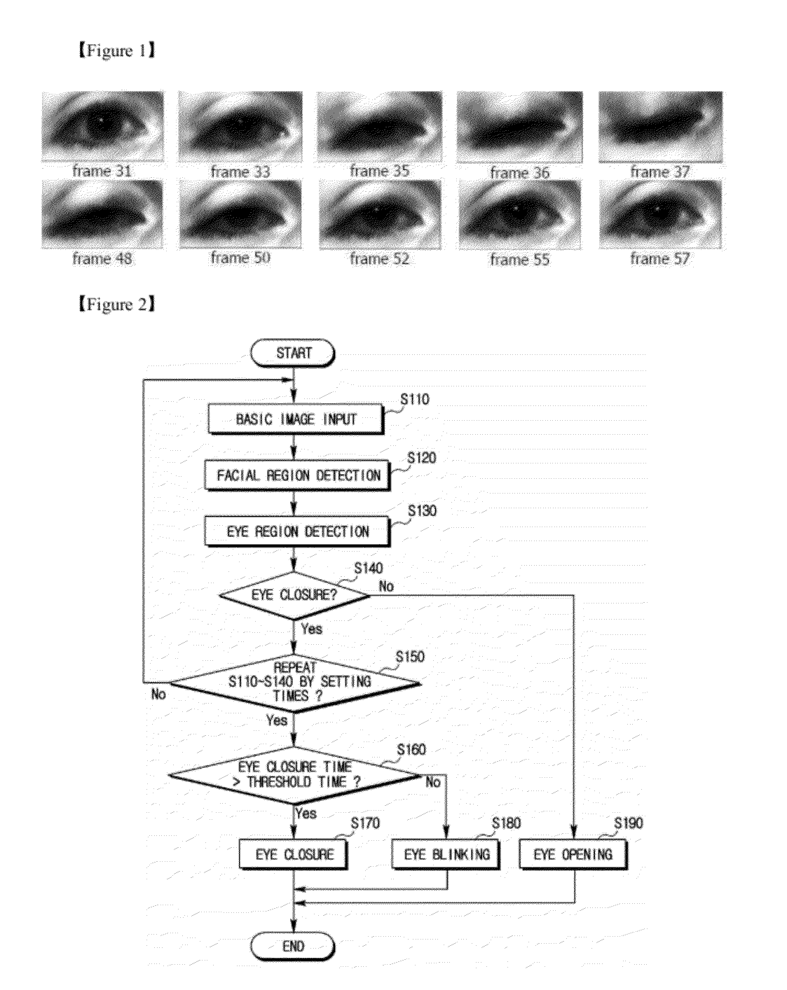

FIG. 1 is an image showing various eye states. The present embodiment can discriminate a variety of eye status illustrated in FIG. 1 as an eye opening, an eye closure and an eye blinking state.

FIG. 2 is a flow chart indicating an eye state detecting method according to the present embodiment.

A basic image paused from a continuous image is input (S110). The paused initial image can be a grey image.

Next, a facial region is detected from the paused initial image (S120). Here, a facial region detection may be performed by obtaining the coordinates of a face boundary. The face region detection may use various methods such as a Haar based face detection or a template matching method. For example, in the case of using a template matching method, a template matching operation is performed by an input basic image and a multi-scale template. After a template matching operation is using the input basic image and the multi-scale template, a face image detection is outputted. Here, the multi-scale template is an average facial template of tens of unequal sizes. The number of face templates may be diversified besides the above-mentioned ones.

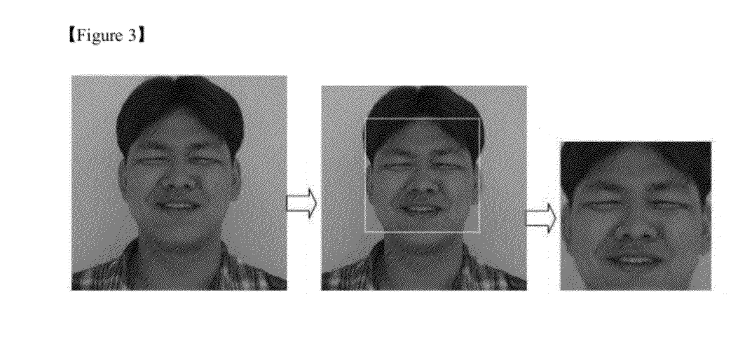

FIG. 3 is a diagram showing a result of a facial region detection according to the present embodiment.

Again referring to FIG. 2, an eye region is detected from a facial region (S130). Here, the detection of an eye region refers to a marginal region around eyes at up/down and left/right sides, not being an exact region indicating eyes. Such an eye region can be detected using eye geometry. For example, assuming that a horizontal length of a face is X and a vertical length is Y in a usual way, a position of the left eye becomes (¼X, ⅕Y) and a position of the right eye becomes ( 3/16X, ⅕Y). By a marginally setting area around such positions, an eye region can be detected.

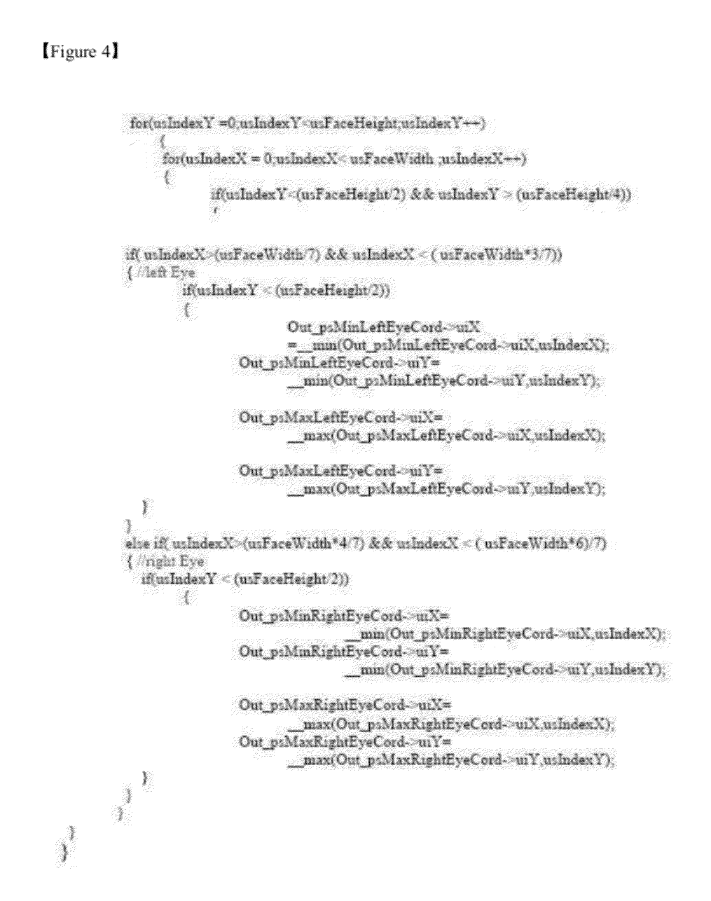

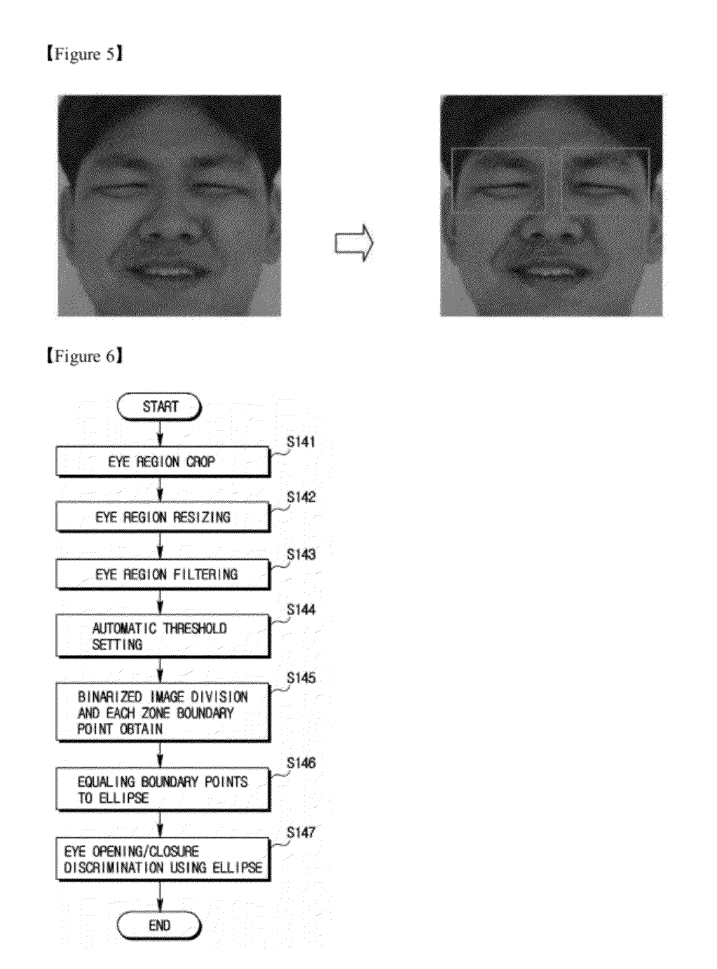

FIG. 4 is a diagram showing one example of an eye region detecting algorithm according to the present embodiment, and FIG. 5 is a diagram showing eye region detecting results according to the present embodiment.

Next, an eye closure and an eye opening are preliminarily discriminated (S140). Here, a preliminary determination of the eye closure and the eye opening refers to passing over to the following step that in a case determined as the eye closure through the discrimination of the eye closure and the eye opening, an eye status is finally determined into the eye opening, and an eye closure determined case, again requiring a discrimination of whether it is an eye closure or an eye blinking, preliminarily determines as the eye closure and then discriminates whether it is the eye closure or the eye blinking. S140 will be described in detail in below. In S140, an eye status may be discriminated as an eye opening state (S190). When determined as an eye closure state in S140, S110 through S140 is repeated by setting times (S150). After repeating S110 through S140 by setting times, flow determines if an eye closure discriminated time is greater than a set threshold time (ms) (S160). When the eye closure discriminated time is greater than a set threshold time (ms), flow discriminates it as the eye closed state (S170). When the eye closure discriminated time is not greater than a set threshold time (ms), it is discriminated as an eye blink state (S180).

Herein, a repeating step is S110 through S140 in the present embodiment, but from S110 up to any one step of hereinafter described S141˜S147 may be reiterated. For example, from S110 to S145 in below described may be repeated by setting times.

Hereinafter, S140 discriminating an eye closure and an eye opening will be described in detail.

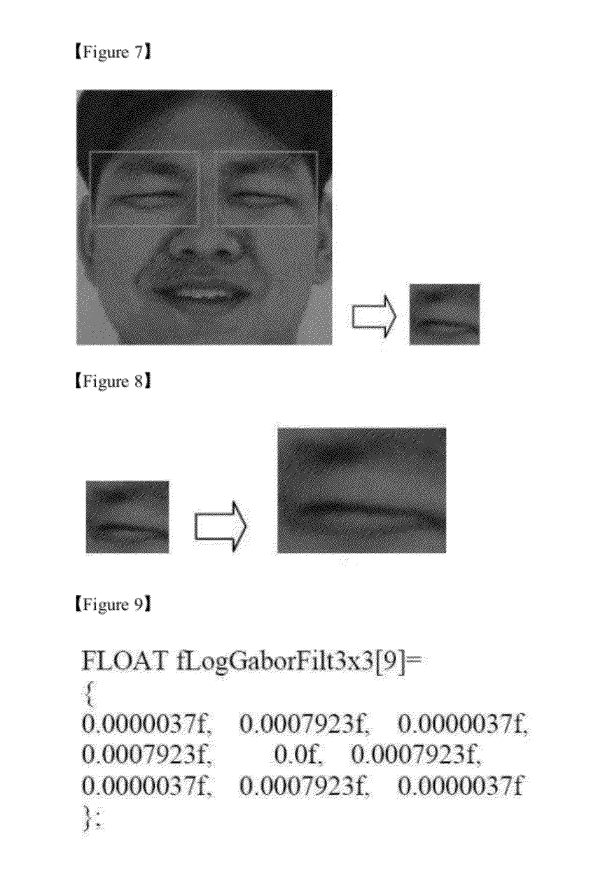

FIG. 6 is a flow diagram showing an eye opening/closure discrimination step according to the present embodiment. First, an eye region obtained according to S130 is cut off (S141). This can be performed using an image cropping function of an ISP (Image Signal Processor). FIG. 7 is a diagram showing a cropped eye region according to the present embodiment.

Then, the cut eye region becomes resized (S142). For example, the eye region is 80 60 resized. FIG. 8 is a diagram showing an eye region being 80 60 resized according to the present embodiment.

Next, the resized eye region becomes filtered (S143). For example, a Log Gabor filtering is performed using a convolution. On a linear frequency scale, a Log Gabor function is a translated function as shown in the following Equation 1.

$$G ( w ) = {e}^{( - log ( w / {w}_{o} ) 2 ) / ( 2 ( log ( k / {w}_{o} ) 2 )} \qquad [ Math Figure 1 ]$$

Here, w0 denotes a filter center frequency.

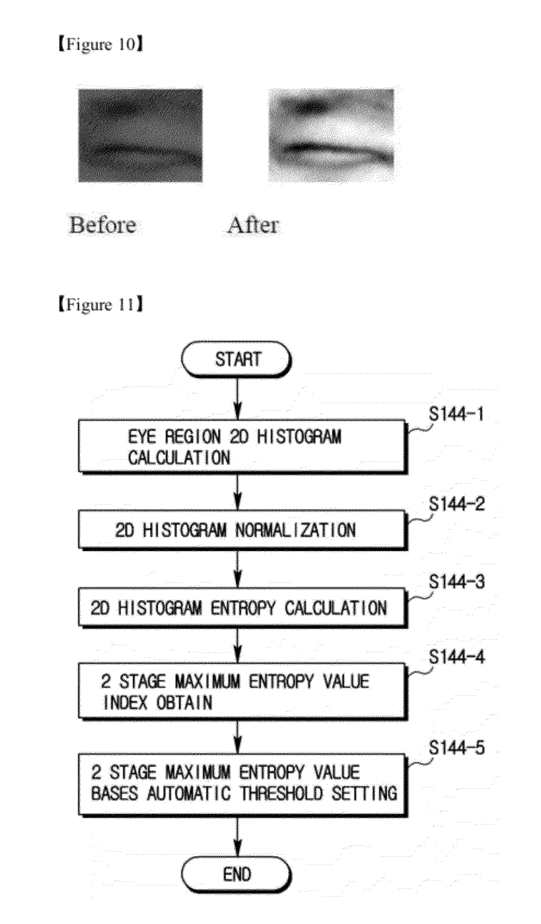

To obtain a filter versus a certain form, a term k/w0 may constantly maintain for a different w0. For example, k/w0, that is 0.74, may be a filter bandwidth of approximately one octave, k/w0, that is 0.55, may be a filter bandwidth of approximately two octaves, and k/w0, that is 0.41, may be a filter bandwidth of approximately three octaves. FIG. 9 indicates a Log Gabor kernel for a convolution used in the present embodiment, and FIG. 10 is a diagram showing a filtered eye region according to the present embodiment. A filtering using a convolution in the present embodiment can be performed using the following Equation 2.

$${I}^{′} ( x , y ) = {\sum }_{i = - \frac{n}{2}}^{\frac{n}{2}} {\sum }_{j = - \frac{m}{2}}^{\frac{m}{2}} I ( x + i , y + j ) h ( i , j ) \qquad [ Math Figure 2 ]$$

Here, h denotes a convolution kernel matrix, m and n denoting convolution kernel matrix dimensions, I′(x,y) denoting a new image, and I(x,y) denoting an input image.

Then, an automatic threshold setting is performed (S144).

Hereinafter, S144, that is an automatic threshold setting step, will be described in detail.

FIG. 11 is a flow diagram indicating an automatic threshold setting step according to the present embodiment.

Referring to FIG. 11, a 2D histogram of the eye region is calculated (S144-1). Here, a histogram refers to the statistical expression of different image pixel frequencies within an image. The 2D histogram represents the number of corresponding pixels with a different light source level. An image histogram may represent how many pixels having an accurate light source intensity exist in an original image. Because images applied to the present embodiment may be diversified in size, one dimension integer array can be used to store a histogram value. A 2D histogram calculation may be performed using a loop and a 256 element index integer array within image pixels.

Herein, it would be apparent to one skilled in the art that an array number can be diverse besides the above-mentioned one. The succeeding is an algorithm indicating one example of calculating a 2D histogram according to the present embodiment.

for (usIndexX = 0; usIndexX < usHeight*usWidth; usIndexX++)
{
gssHistogramGrey[0][pucGrey[usIndexX]]++;
}

Here, pucGrey[usIndexX] is a byte array holding information on 2D image brightness, and gssHistogramGrey[0] is a 256 element integer array holding a 2D image histogram. Then, a 2D histogram is normalized (S144-2). That is, a 2D histogram stored in histogram 256 element integer array may be normalized. A normalized histogram indicates a probability distribution of different pixel values. A normalized process may be performed by dividing each one of histogram 256 array element by the entire pixel number. The following is an algorithm indicating one example of normalizing a 2D histogram according to the present embodiment.

for(usIndex=0:usIndex<256:usIndex++)
{

| | |
|---|---|
| gdHistogramGreyNormalized[usIndex] | = |

(DOUBLE)gssHistogramGrey[0][usIndex]/(DOUBLE)(us
X*usY):

}

Then, 2D histogram entropy is calculated (S144-3). Herein, entropy is a numerical value indicating the average value of uncertainty.

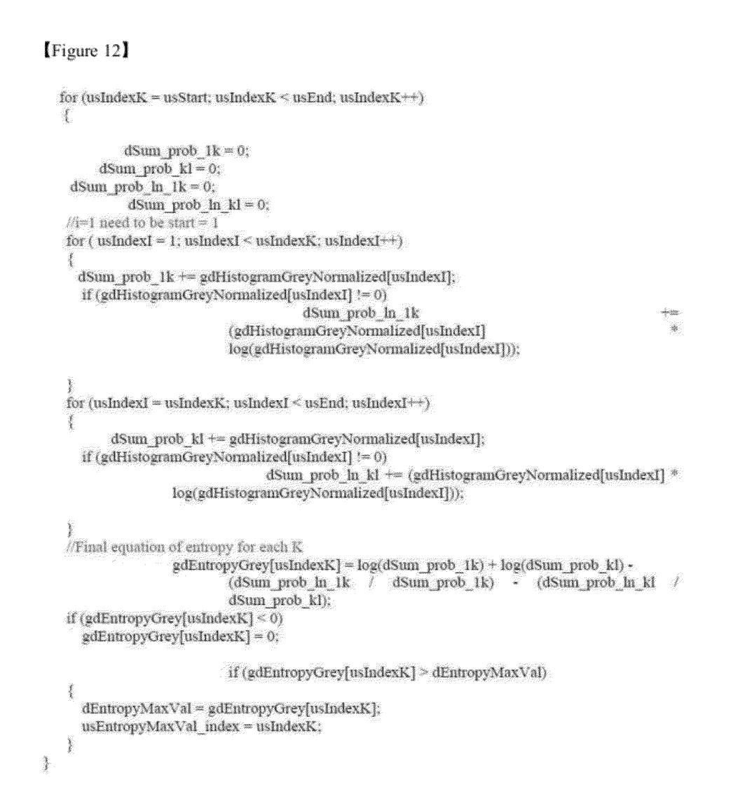

FIG. 12 is a diagram showing one example of an algorithm that calculates the 2D histogram entropy according to the present embodiment. Referring to FIG. 12, after 2D histogram entropy function is performed, image entropy may be held in 2D 256 element double precision array ‘gdEntropyGrey[k]’. The function can be used in determining which pixels have a large portion of information capacity within an image.

Then, a maximum entropy value index of two stages is obtained (S144-4). Next, an automatic threshold value is set based on two stages of a maximum entropy value (S144-4). After calculating 2D histogram entropy value and then detecting a maximum value, a threshold value can be obtained based on the maximum point. The threshold value may be obtained within a preset percentage around the detected maximum value. Herein, a multistage 2D entropy function also can be used. The multistage entropy function may be different from a single stage in terms of a repeating number and a histogram division by part A and part B. For example, a 4-stage entropy function may provide a probability on a threshold input image on 4 layers automatically. Dividing a histogram by few times using an entropy maximum value calculation throughout a selected region inside the histogram is required. After calculating a first entropy maximum value and then computing an entropy maximum value between 0 and the first maximum point, an entropy maximum point between the first maximum value and histogram 255 element may be calculated.

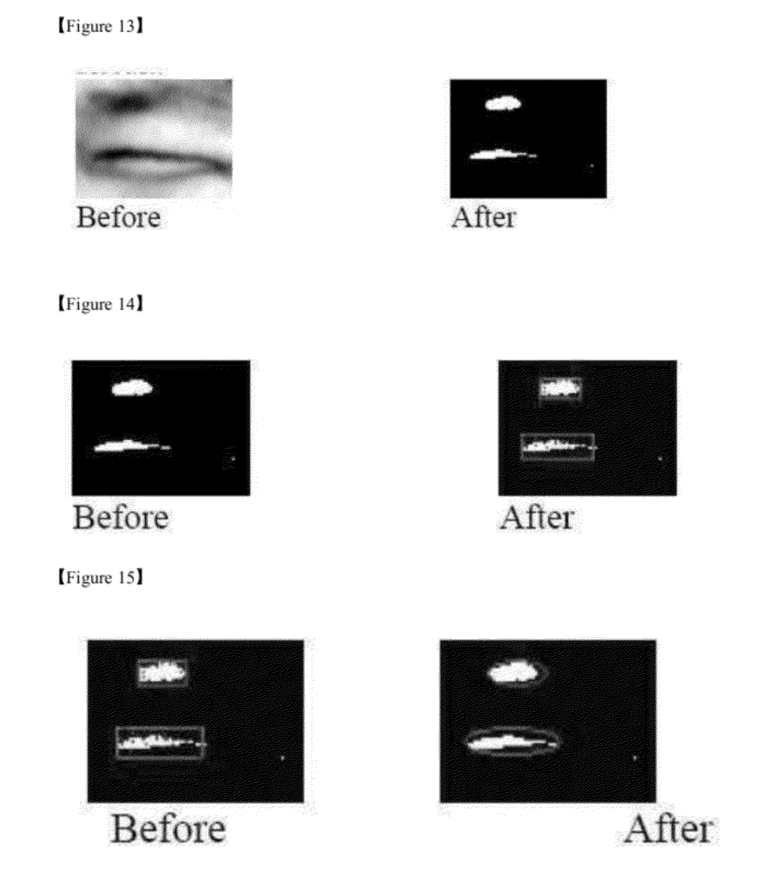

Also, a histogram equalization may also be used on a threshold image. ‘Histogram equalization’ is a simple process of grouping all small histogram columns into one. After such a grouping, an image pixel replacement regarding a histogram modification may be performed. For 2D histogram equalization, a histogram average value may be calculated. After that, a loop is created, all histogram columns from position 0 to 255 are checked and whether a corresponding histogram column is smaller than an average value of a global histogram exceeding the average value is checked. In that case, the method passes over to a next column, dealing this value as a first ac value. Added all positions may be marked as a grey level replacement candidate. If the next column has greater value than the average value, the first value may not be added to that value and passes over to the following column. FIG. 13 is a diagram showing results before and after an automatic threshold setting according to the present embodiment.

Again referring to FIG. 6, a binary-coded image is divided and boundary points of each divided zone are obtained (S145). The binary-coded image division may be performed as shown below. First, the part of an image to be unused is initialized. Then, the image is divided using 4 connected components. The divided ones are labeled, and a zone ID is fixed. Then, a zone size is calculated, and new IDs for zones are computed in a size order. Next, center and circumferential boxes are calculated, and zone edge points are computed. FIG. 14 is a diagram showing a binary-coded image division and a result of performing a divided each zone boundary points obtaining step.

Then, an ellipse is equaled to boundary points of each zone (S146). That is, a most agreeable ellipse to a set of boundary points is calculated. For example, a most agreeable ellipse may be computed using 6 boundary points. FIG. 15 is a diagram showing a result of performing an ellipse versus each zone boundary points equaling step.

Then, using an obtained ellipse an eye opening/closure state is discriminated (S147). For instance, by calculating a roundness or an area of an ellipse an eye opening/closure state may be discriminated. In the case of discriminating an eye opening/closure state by an ellipse area, a range of an ellipse area discriminated into an eye closure may be set. For example, in a case the ellipse area is within 5 mm′ through 30 mm′, discriminated as an eye closure. Also, the eye closure can be discriminated based on a geometry of an eye and an eyelid.

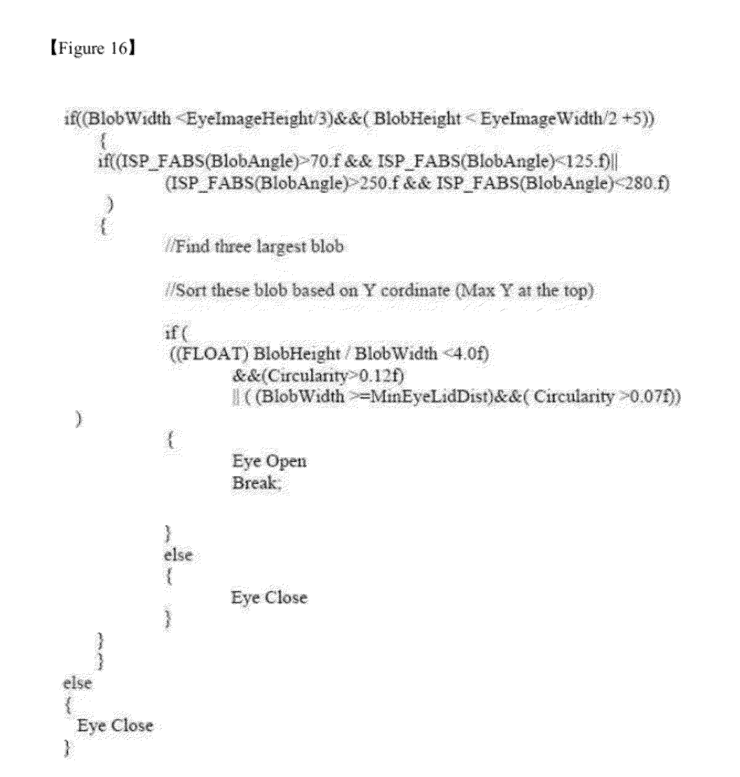

FIG. 16 is an algorithm showing one example of an eye state detecting apparatus according to the present embodiment.

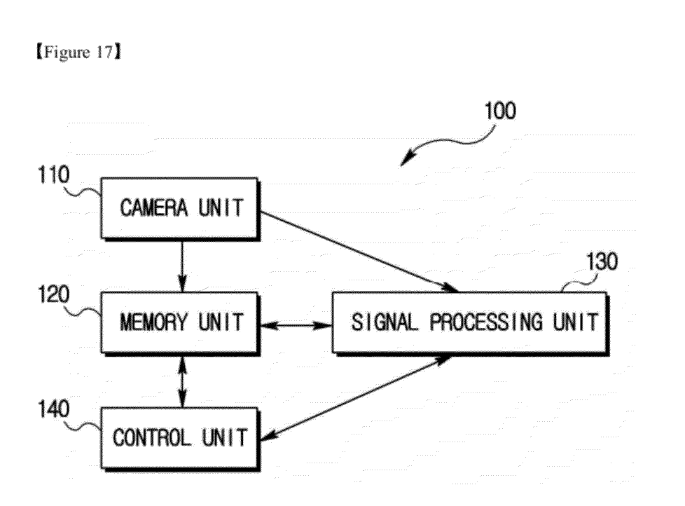

FIG. 17 is a block diagram indicating an eye state detecting apparatus according to the present embodiment.

Referring to FIG. 17, an eye state detecting apparatus includes a camera unit 110, a memory 120, a signal processing unit 130 and a control unit 140. A camera unit 110 take a photograph of a continuous image and outputs the photographed image to a memory 120. The memory 120 receives and stores the photographed image. A signal processing part 130 detects an eye status according to the present embodiment for a digital image stored in the memory 120 to determine the eye status into an eye closure, an eye blinking or an opening and outputs the result to the memory 120 or a control unit 140. The control unit 140 outputs a control signal to a control needed module according to a determination result of an eye status. Here, the control unit 140 may not be provided unlike as shown in the figure. With no control unit 140, the signal processing unit 130 outputs the determined eye status to outside.

For example, if an eye state detecting apparatus is connected to an alarm generation unit of a driver monitoring system, and a signal processing unit 130 determines a subject into an eye closure, a control unit 140 may send out a signal generating an alarm sound to an alarm generation unit. As another example, when the eye state detecting apparatus is connected to a camera, the signal processing unit 130 determines the subject into an eye blinking, the control unit 140 may deliver a control signal to the camera to capture an optimal photographing time.

The algorithm shown in the present embodiment is merely one example of an algorithm variously expressed to realize the embodiment, and it would be apparent to one skilled in the art that a different algorithm from such one example also can implement the present embodiment.

A term ‘unit’ used in the present embodiment means software or a hardware component such as FPGA (field-programmable gate array) or ASIC, and ‘unit’ performs any mission. However, ‘unit’ is not limited to software or hardware. ‘Unit’ may be configured to exist in an addressable storage medium and also may be configured to execute one or more processors. Therefore, as one example, ‘unit’ includes constituents such as software components. object-oriented software components, class components and task components, processes, functions, attributes, procedures, subroutines, segments in a program code, drivers, a firmware, a microcode, a circuit, data, a database, data structures, tables, arrays, and variables. Components and a function provided in ‘unit(s)’ can be coupled to a smaller number of components and ‘unit(s)’ or more divided to further components and ‘unit(s)’. In addition, components and ‘unit(s)’ may be implemented to execute one or more CPUs in a device or a secure multimedia card.

The entire described functions may be performed by processors such as a microprocessor, a controller, a microcontroller, ASIC (Application Specific Integrated Circuit) according to software or a program code coded to carry out the described function. The design, development and implementation would be obvious to those skilled in the art on the basis of the description of the present invention.

While the present invention has been described in detail hereinabove through embodiments, those skilled in the art would understand that various modifications can be made in the present invention without departing from the spirit and scope of the present invention.

Therefore, the scope of the present invention should not be restricted to the described embodiment, but would encompass all embodiments that fall in the accompanying claims.

### INDUSTRIAL APPLICABILITY

The present invention is related to an eye state detecting method and apparatus for a real-time eye tracking, and the eye state detecting method and apparatus can be applied to a driver monitoring system, an eye-movement based information display system, a computer game using an eye-movement and an eye-blinking detectable camera, etc.

1. A method of detecting an eye state into an eye opening, an eye closure and an eye blinking from a continuous image containing a face, comprising:
(a) inputting a basic motionless image from the continuous image;
(b) detecting a facial region from the basic motionless image;
(c) detecting an eye region from the facial region;
(d) preliminarily discriminating an eye opening and an eye closure by dividing images through the setting of an automatic threshold from the eye region and obtaining boundary points of the divided zones and using an ellipse most properly equal to the boundary points; and
(e) discriminating as an eye closure if an eye closure time calculated by repeating the step (a) through the step (d) as much as a preset times is greater than a preset threshold time and discriminating as an eye blinking if it is not greater, in a case preliminarily discriminated in the eye closure in the step (d).

2. The method of claim 1, wherein the step (b) detects a facial region using a Haar based face detection or a template matching method.

3. The method of claim 1, wherein the step (c) detects an eye region using eye geometry.

4. The method of claim 1, wherein the step (d) includes,
(d-1) filtering the eye region;
(d-2) setting an automatic threshold into the eye region;
(d-3) dividing a binary image of the eye region and obtaining a boundary point of the divided zones;
(d-4) equaling a most proper ellipse to the boundary points; and
(d-5) preliminarily discriminating an eye opening and an eye closure using the ellipse.

5. The method of claim 4, wherein before the step (d-1), further including the step of cropping and resizing the eye region.

6. The method of claim 4, wherein the step (d-1) performs a Log Gabor filter using a convolution.

7. The method of claim 6, wherein the Log Gabor filtering uses the following equation,
$${I}^{′} ( x , y ) = {\sum }_{i = - \frac{n}{2}}^{\frac{n}{2}} {\sum }_{j = - \frac{m}{2}}^{\frac{m}{2}} I ( x + i , y + j ) h ( i , j )$$
using the convolution, where, h denotes a convolution kernel matrix, m and n denoting convolution kernel matrix dimensions, I′(x,y) denoting a new image, and I(x,y) denoting an input image.

8. The method of claim 4, wherein the step (d-2) includes,
(dd-1) calculating a 2D histogram meaning the statistical expression of different image pixel frequencies within the eye region image;
(dd-2) normalizing the 2D histogram into a probability distribution of different pixel values;
(dd-3) calculating an entropy, that is a numerical value representing an average value of uncertainty from the normalized 2D histogram;
(dd-4) obtaining a maximum entropy value index of two stages; and
(dd-5) setting an automatic threshold based on the maximum entropy value of two stages.

9. The method of claim 8, wherein the step (dd-2) normalizes the 2D histogram by dividing each one of histogram elements by an overall pixel number in an image.

10. The method of claim 8, wherein one dimension integer array is used to store the 2D histogram calculated in the step (dd-1).

11. The method of claim 8, wherein the step (dd-5) obtains a threshold value within a preset percent value around the detected maximum entropy value.

12. The method of claim 8, wherein after the step (dd-3), the method performs a histogram equalization that groups all small histogram columns into one.

13. The method of claim 4, wherein in the step (d-4), the method equals a most proper ellipse using at least 6 boundary points.

14. The method of claim 4, wherein in the step (d-5), the method preliminarily discriminates an eye opening and an eye closure using a roundness or an area of the ellipse.

15. The method of claim 1, wherein the paused initial image is a grey image.

16. A storage medium embodying a program of commands that can be executed by a digital processing apparatus to perform an eye state detecting method recited in claim 1, and recording a program readable by the digital processing apparatus.

17. An apparatus of detecting an eye state into an eye opening, an eye closure and an eye blinking from a continuous image containing a face, comprising:
a camera unit photographing the continuous image; and
a signal processing unit discriminating an eye state into an eye opening, an eye closure and an eye blinking by performing an eye state detection based on an eye state detection method recited in claim 1 from the continuous image.

18. A method of detecting an eye state into an eye opening, an eye closure and an eye blinking from a continuous image containing a face, comprising:
(a) inputting a basic, motionless image from the continuous image;
(b) detecting a facial region and an eye region from the basic motionless image;
(c) Log-Gabor filtering the detected eye region;
(d) setting an automatic threshold into the eye region;
(e) dividing binary images of the eye region and obtaining boundary points of divided zones;
(f) equaling a most proper ellipse to the boundary points;
(g) preliminarily discriminating an eye opening and an eye closure using the ellipse; and
(h) discriminating as an eye closure if an eye closure time calculated by repeating the step (a) through the step (g) as much as a preset times is greater than a preset threshold time and discriminating as an eye blinking if it is not greater, in a case preliminarily discriminated in the eye closure in the step (g).

19. The method of claim 18, wherein the step (c) performs a Log-Gabor filter using a convolution.

20. The method of claim 19, wherein the Log Gabor filtering uses the following equation,
$${I}^{′} ( x , y ) = {\sum }_{i = - \frac{n}{2}}^{\frac{n}{2}} {\sum }_{j = - \frac{m}{2}}^{\frac{m}{2}} I ( x + i , y + j ) h ( i , j )$$
, using the convolution, where, h denotes a convolution kernel matrix, m and n denoting convolution kernel matrix dimensions, I′(x,y) denoting a new image, and I(x,y) denoting an input image.

21. The method of claim 18, wherein the step (d) includes, (d-1) calculating a 2D histogram meaning the statistical expression of different image pixel frequencies within the eye region image;
(d-2) normalizing the 2D histogram into a probability distribution of different pixel values;
(d-3) calculating an entropy, that is a numerical value representing an average value of uncertainty from the normalized 2D histogram;
(d-4) obtaining a maximum entropy value index of two stages; and
(d-5) setting an automatic threshold based on the maximum entropy value of two stages.

22. The method of claim 21, wherein the step (d-2) normalizes the 2D histogram by dividing each one of histogram elements by an overall pixel number in an image.

23. The method of claim 21, wherein one dimension integer array is used to store the 2D histogram calculated in the step (d-1).

24. The method of claim 21, wherein the step (d-5) obtains a threshold value within a preset percent value around the detected maximum entropy value.

25. The method of claim 21, wherein after the step (d-3), the method performs a histogram equalization that groups all small histogram columns into one.

26. The method of claim 18, wherein in the step (d-4), the method equals a most proper ellipse using at least 6 boundary points.

27. The method of claim 18, wherein in the step (d-5), the method preliminarily discriminates an eye opening and an eye closure using a roundness or an area of the ellipse.

28. The method of claim 18, wherein the paused initial image is a grey image.

29. A storage medium embodying a program of commands that can be executed by a digital processing apparatus to perform an eye state detecting method recited in claim 18, and recording a program readable by the digital processing apparatus.
